(19) United States
(12) Patent Application Publication
(10) Pub. No.: US 2026/0210296 A1
(43) Pub. Date: Jul. 23, 2026

(54) IMPROVING THE DYNAMIC BEHAVIOR OF THE DRIVE SHAFT OF A FAN OF AN AERONAUTICAL PROPULSION SYSTEM

(71) Applicant: SAFRAN AIRCRAFT ENGINES, Paris (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/140,126

(22) PCT Filed: Dec. 22, 2023
(86) PCT No.: PCT/FR2023/052097

§ 371 Date: Jul. 22, 2025

(30) Foreign Application Priority Data
Dec. 22, 2022 (FR) FR2214337

(51) Int. Cl. F02C 7/36; F02C 3/107; F02C 7/06

(52) U.S. Cl. CPC F02C 7/36; F02C 3/107; F02C 7/06; F05D 2220/323

(57) ABSTRACT

An aeronautical propulsion system includes a fan rotor connected to a fan shaft, a drive turbine that drives the fan rotor by a drive shaft about an axis of rotation, a reduction structure that couples the drive shaft and the fan shaft to drive the fan shaft at a rotation speed less than the rotation speed of the drive shaft, bearings that center the drive shaft with respect to the axis of rotation, the bearings including a front bearing extending upstream of a combustion chamber of the propulsion system and two rear bearings extending downstream of the combustion chamber. A redline speed of the drive shaft is based on a mean radius of a rear bearing closest to the front bearing, a distance between a center of gravity of the front bearing and a center of gravity of the rear bearing closest to the front bearing, and a constant.

### TECHNICAL FIELD

The present application relates in general to the field of propulsion systems, and more particularly to aeronautical propulsion systems comprising a ducted or unducted fan with a high, or even very high, bypass ratio.

### BACKGROUND

A propulsion system generally comprises, from upstream to downstream in the direction of gas flow, a fan section, a compressor section which may comprise a low-pressure compressor and a high-pressure compressor, a combustion chamber and a turbine section which may comprise, in particular, a high-pressure turbine and a low-pressure turbine. The high-pressure compressor is rotated by the high-pressure turbine by means of a high-pressure shaft. The fan and, if applicable, the low-pressure compressor are rotated by the low-pressure turbine by means of a low-pressure shaft.

Technological research efforts have already enabled significant improvements in the environmental performance of aircraft. The Applicant takes into account the impacting factors in all phases of design and development in order to obtain aeronautical components and products that consume less energy, are more environmentally friendly and whose integration and use in civil aviation has moderate environmental consequences, with the aim of improving aircraft energy efficiency.

In order to improve the propulsion efficiency of the propulsion system and reduce its specific consumption and the noise emitted by the fan section, propulsion systems having a high BPR (bypass ratio, corresponding to the ratio between the secondary air flow and the primary air flow) have been proposed. To achieve such bypass ratios, the fan section can be decoupled from the low-pressure turbine, thus enabling their respective rotation speeds to be independently optimised. In general, decoupling is achieved by means of a reduction mechanism placed between the upstream end of the low-pressure shaft and a rotor of the fan section. The rotor of the fan section is then driven by the low-pressure shaft, via the reduction mechanism, at a lower rotation speed than that of the low-pressure shaft.

The current trend is to increase the overall pressure ratio of the propulsion system, which corresponds to the ratio between the outlet pressure of the high-pressure compressor and the inlet pressure of the fan. This makes it possible to increase the inlet pressure of the gases in the combustion chamber, and thus further improve the overall efficiency of the propulsion system. Increasing the overall pressure ratio therefore requires an increase in the pressure ratio of the high-pressure compressor and/or the low-pressure compressor, all the more so since, in parallel, an attempt is made to reduce the fan pressure ratio for the reasons explained above.

One of the consequences is that the torque to be transmitted by the low-pressure shaft to the reduction mechanism is reduced compared with a direct-drive propulsion system. The low-pressure shaft can therefore have a smaller diameter, making it easier to integrate the high-pressure spool into the propulsion system. However, this reduction in the diameter of the low-pressure shaft has the effect of reducing the frequency of its natural modes. In addition, increasing the rotation speed of the low-pressure shaft extends the operating range of the low-pressure shaft. As a result, the low-pressure shaft could be likely to exceed a critical speed and could be likely to resonate (unless design precautions are taken into account). At resonance, which occurs when the critical speed of the low-pressure shaft is exceeded, the shaft undergoes over-stress phenomena which amplify the deformations and forces caused by the (unavoidable) imbalances of the low-pressure shaft. Under these conditions, the low-pressure shaft is said to be supercritical.

Thus, changing the diameter of the low-pressure shaft has an impact on its dynamic behaviour and modifies the positioning of its supercritical modes. A propulsion system revolving at a critical speed under steady-state conditions risks rapid degradation, which must be avoided.

### SUMMARY

One aim of the present application is to optimise the propulsion system in order to increase its efficiency while controlling the dynamic behaviour of the fan rotor drive shaft.

For this purpose, an aeronautical propulsion system is proposed, comprising:
a fan rotor connected to a fan shaft;
a drive turbine configured to drive the fan rotor by means of a drive shaft, about an axis of rotation;
a reduction mechanism coupling the drive shaft and the fan shaft in order to drive the fan shaft at a rotation speed less than the rotation speed of the drive shaft;
bearings configured to centre the drive shaft with respect to the axis of rotation, the bearings comprising a front bearing extending upstream of a combustion chamber of the propulsion system and two rear bearings extending downstream of the combustion chamber, wherein a redline speed of the drive shaft satisfies the following formula:

$$XN \geq A * \frac{{R}_{11 b}}{{d}_{1}^{2}} * {10}^{5}$$

where: XN is the redline speed of the drive shaft, in revolutions per minute (rev/min);
R_{11b} is a mean radius of the rear bearing closest to the front bearing, in millimetres (mm); and
d₁ is a distance between a centre of gravity of the front bearing and a centre of gravity of the rear bearing closest to the front bearing, in millimetres (mm); and
A=5500 mm*rev/min.

Some preferred, but non-limiting, characteristics of the propulsion system according to the first aspect are the following, taken individually or in combination:
the redline speed of the drive shaft further satisfies the following formula:

$$\begin{matrix}XN \leq B * \frac{{R}_{11 b}}{{d}_{1}^{2}} * 1 {0}^{5} \\ where B = 8500 mm * rev / min . ;\end{matrix}$$

each bearing is associated with a bearing mode damper;
the bearing mode dampers comprise damping by pressurised fluid film
   the bearing mode dampers comprise a deformable cage mounted between a ring of each bearing and a stator part of the propulsion system;
the bearings comprise an additional front bearing extending upstream of the front bearing;
the redline speed of the drive shaft further satisfies the following formula:

$$XN \geq \frac{1}{C} * \frac{{R}_{11 b}}{{d}_{1}^{2}} * 1 {0}^{8} * ( \frac{{R}_{m}}{{d}_{2}} * 1000 - {E}_{1} )$$

where: Rm is a mean radius of the drive turbine, in millimetres (mm); d₂ is a distance between the centres of gravity of the rear bearings, in millimetres (mm); and C=170 (mm*rev/min)⁻¹ and E₁=378.
the redline speed of the drive shaft (11) also satisfies the following formula:

$$XN \leq \frac{1}{C} * \frac{{R}_{11 b}}{{d}_{1}^{2}} * 1 {0}^{8} * ( \frac{{R}_{m}}{{d}_{2}} * 1000 + {E}_{2} )$$

where: Rm is a mean radius of the drive turbine, in millimetres (mm); d₂ is a distance between the centres of gravity of the rear bearings, in millimetres (mm); and C=170 (mm*rev/min)⁻¹ and E₂=180;
the bearings comprise at least one front bearing and exactly two rear bearings;
the propulsion system further comprises an additional turbine configured to drive an additional compressor by means of an additional shaft, the additional shaft being configured to revolve at a higher speed than the drive shaft about the axis of rotation, the additional turbine being two-stage;
a mean radius of a bore of the additional turbine satisfies the following formula:

$${R}_{m\_a} \leq E * {L}_{HP}^{2} * XN * {10}^{- 9} + {F}_{1}$$

where: R_{m_a} is the mean radius of the bore of the additional turbine in millimetres (mm); L_{HP} is a distance between an inlet of the additional compressor and an outlet of the additional turbine in millimetres (mm); and E=3.15 (mm.rev/min)⁻¹ and F₁=23 millimetres (mm);
a mean radius of a bore of the additional turbine (7) satisfies the following formula:

$${R}_{m\_a} \geq E * {L}_{HP}^{2} * XN * 1 {0}^{- 9} + {F}_{2}$$

where: R_{m_a} is the mean radius of the bore of the additional turbine in millimetres (mm); L_{HP} is a distance between an inlet of the additional compressor and an outlet of the additional turbine in millimetres (mm); and E=3.15 (mm.rev/min)⁻¹ and F₂=13 millimetres (mm);
a mean radius of a bore of the additional turbine (7) satisfies the following formula:

$${R}_{m\_a} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1}$$

where: D₉ is the diameter of the fan rotor in millimetres, measured in a plane normal to the axis of rotation at an intersection between a tip and a leading edge of the blades of the fan rotor; BPR is the bypass ratio of the propulsion system and is measured when the propulsion system is stationary, at take-off speed, in a standard atmosphere and at sea level; Tₑ is the inlet temperature of the drive turbine when the propulsion system is stationary, at take-off speed, in a standard atmosphere and at sea level and is expressed in degrees Celsius; T_{ref}=273K; n is the number of stages in the additional turbine and the additional compressor, GAMMA is the adiabatic coefficient of the air; and K=6.76, L=153.6 m⁻¹·(° C.)^{-1/2}·(rev/min)⁻¹, M=421 mm·(° C.)^{1/2} and N₁=−11 millimetres (mm);
a mean radius of a bore of the additional turbine (7) satisfies the following formula:

$${R}_{{m}_{a}} \leq K * {( L * \sqrt{\frac{{D}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$

where: D₉ is the diameter of the fan rotor in millimetres, measured in a plane normal to the axis of rotation at an intersection between a tip and a leading edge of the blades of the fan rotor; BPR is the bypass ratio of the propulsion system and is measured when the propulsion system is stationary, at take-off speed, in a standard atmosphere and at sea level; Tₑ is the inlet temperature of the drive turbine when the propulsion system is stationary, at take-off speed, in a standard atmosphere and at sea level and is expressed in degrees Celsius; T_{ref}=273K; n is the number of stages in the additional turbine and the additional compressor; GAMMA is the adiabatic coefficient of the air; and K=6.76, L=153.6 m⁻¹·(° C.)^{-1/2}·(rev/min)⁻¹, M=421 mm·(° C.)^{1/2} and N₁=−21 millimetres (mm);
a mean radius of the bore of the additional turbine (7) is at least equal to:

$${R}_{m \_ a} \geq G * F N * B P R * 1 {0}^{- 4} + H$$

where: R_{m_a} is the mean radius of the bore of the additional turbine in millimetres (mm); FN is the thrust of the fan rotor measured when the propulsion system is stationary, at take-off speed, in a standard atmosphere and at sea level and is expressed in newtons (N); BPR is the bypass ratio of the propulsion system and is measured when the propulsion system is stationary, at take-off speed, in a standard atmosphere and at sea level; and G=0.16 millimetres per newton (mm/N) and H=18 millimetres (mm);
a mean radius of the bore of the high-pressure turbine (7) is at most equal to:

$${R}_{m \_ a} \leq I * FN * B P R * 1 {0}^{- 4} + J$$

where: R_{m_a} is the mean radius of the bore of the additional turbine in millimetres (mm); FN is the thrust of the fan rotor measured when the propulsion system is stationary, at take-off speed, in a standard atmosphere and at sea level and is expressed in newtons (N); BPR is the bypass ratio of the propulsion system and is measured when the propulsion system is stationary, at take-off speed, in a standard atmosphere and at sea level; and I=0.16 millimetres per newton (mm/N) and J=28 millimetres;
the mean radius of the bore of the additional turbine is at most equal to 300 mm;
the additional compressor (5) comprises at least eight stages and at most eleven stages;
the drive turbine (8) comprises at least three stages and at most five stages;
a reduction ratio of the reduction mechanism is greater than or equal to 2.5 and less than or equal to 11.

According to a second aspect, an aircraft is proposed comprising at least one propulsion system according to the first aspect, attached to the aircraft by means of a mast.

According to a third aspect, a method is proposed for dimensioning a propulsion system comprising a reduction system coupling a drive shaft and a fan rotor to drive the fan rotor at a speed less than a speed of the drive shaft, and bearings configured to centre the drive shaft with respect to the axis of rotation, the bearings comprising a front bearing extending upstream of a combustion chamber of the propulsion system and two rear bearings extending downstream of the combustion chamber, the propulsion system being dimensioned so that a redline speed of the drive shaft satisfies the following formula:

$$X N \geq A * \frac{{R}_{11 b}}{{d}_{1}^{2}} * 1 {0}^{5}$$

where: XN is the redline speed of the drive shaft, in revolutions per minute (rev/min);
R_{11b} is a mean radius of the rear bearing closest to the front bearing, in millimetres (mm); and
d₁ is a distance between a centre of gravity of the front bearing and a centre of gravity of the rear bearing closest to the front bearing, in millimetres (mm); and
A=5500 mm*rev/min.

Some preferred, but non-limiting, features of the dimensioning or manufacturing method according to the second aspect are the following, taken individually or in combination:
the propulsion system is dimensioned such that a redline speed of the drive shaft also satisfies the following formula:

$$X N \leq B * \frac{{R}_{11 b}}{{d}_{1}^{2}} * 1 {0}^{5}$$

$$where B = 8500 mm * rev / min ,$$

the propulsion system is dimensioned such that a redline speed of the drive shaft also satisfies the following formula:

$$X N \geq \frac{1}{C} * \frac{{R}_{11 b}}{{d}_{1}^{2}} * 1 {0}^{8} * ( \frac{{R}_{m}}{{d}_{2}} * 1000 - {E}_{1} )$$

where: Rm is a mean radius of the drive turbine, in millimetres (mm); d₂ is a distance between the centres of gravity of the rear bearings, in millimetres (mm); and C=170 (mm*rev/min)⁻¹ and E₁=378;
the propulsion system is dimensioned such that a redline speed of the drive shaft also satisfies the following formula:

$$X N \leq \frac{1}{C} * \frac{{R}_{11 b}}{{d}_{1}^{2}} * 1 {0}^{8} * ( \frac{{R}_{m}}{{d}_{2}} * 1000 + {E}_{2} )$$

where: Rm is a mean radius of the drive turbine, in millimetres (mm); d₂ is a distance between the centres of gravity of the rear bearings, in millimetres (mm); and C=170 (mm*rev/min)⁻¹ and E₂=180;
the propulsion system further comprises an additional turbine configured to drive a compressor by means of an additional shaft, the additional shaft being configured to revolve at a higher speed than the drive shaft about the axis of rotation, a mean radius of a bore of the additional turbine is a mean radius of a bore of the additional turbine satisfies the following formula:

$${R}_{m\_a} \leq E * {L}_{H P}^{2} * X N * 1 {0}^{- 9} + {F}_{1}$$

where: R_{m_a} is the mean radius of the bore of the additional turbine in millimetres (mm); L_{HP} is a distance between an inlet of the additional compressor and an outlet of the additional turbine in millimetres (mm); and E=3.15 (mm.rev/min)⁻¹ and F₁=23 millimetres (mm);
the propulsion system further comprises an additional turbine (7) configured to drive a compressor by means of an additional shaft, the additional shaft being configured to revolve at a higher speed than the drive shaft about the axis of rotation, a mean radius of a bore of the additional turbine is a mean radius of a bore of the additional turbine satisfies the following formula:

$${R}_{m \_ a} \geq E * {L}_{H P}^{2} * X N * 1 {0}^{- 9} + {F}_{2}$$

where: R_{m_a} is the mean radius of the bore of the additional turbine in millimetres (mm); L_{HP} is a distance between an inlet of the additional compressor and an outlet of the additional turbine in millimetres (mm); and E=3.15 (mm.rev/min)⁻¹ and F₂=13 millimetres (mm);
the propulsion system further comprises an additional turbine configured to drive a compressor by means of an additional shaft, the additional shaft being configured to revolve at a higher speed than the drive shaft about the axis of rotation, a mean radius of a bore of the additional turbine satisfies the following formula:

$${R}_{m \_ a} \leq K * {( L * \sqrt{\frac{{D}_{9}^{2}}{BPR + 1} * {( {T}_{e} + {T}_{ref} )}^{0.5 - \frac{G A M M A}{G A M M A - 1}} * 1 {0}^{3}} * n + M )}^{2} * X N * 1 {0}^{- 9} + {N}_{1}$$

where: D₉ is the diameter of the fan rotor in millimetres (mm), measured in a plane normal to the axis of rotation at an intersection between a tip and a leading edge of the blades of the fan rotor; BPR is the bypass ratio of the propulsion system and is measured when the propulsion system is stationary, at take-off speed, in a standard atmosphere and at sea level; Tₑ is the inlet temperature of the drive turbine when the propulsion system is stationary, at take-off speed, in a standard atmosphere and at sea level and is expressed in degrees Celsius; T_{ref}=273 K; n is the number of stages in the additional turbine and the additional compressor, GAMMA is the adiabatic coefficient of the air; and K=6.76, L=153.6 m⁻¹·(° C.)^{-1/2}·(rev/min)⁻¹, M=421 mm·(° C.)^{1/2} and N₁=−11 millimetres (mm);
the propulsion system further comprises an additional turbine configured to drive a compressor by means of an additional shaft, the additional shaft being configured to revolve at a higher speed than the drive shaft about the axis of rotation, a mean radius of a bore of the additional turbine satisfies the following formula:

$${R}_{m \_ a} \geq K * {( L * \sqrt{\frac{{D}_{9}^{2}}{B P R + 1} * {( {T}_{e} + {T}_{r e f} )}^{0.5 - \frac{G A M M A}{G A M M A - 1}} * 1 {0}^{3}} * n + M )}^{2} * X N * 1 {0}^{- 9} + {N}_{2}$$

where: D is the diameter of the fan rotor in millimetres, measured in a plane normal to the axis of rotation at an intersection between a tip and a leading edge of the blades of the fan rotor; BPR is the bypass ratio of the propulsion system and is measured when the propulsion system is stationary, at take-off speed, in a standard atmosphere and at sea level; Tₑ is the inlet temperature of the drive turbine when the propulsion system is stationary, at take-off speed, in a standard atmosphere and at sea level and is expressed in degrees Celsius; T_{ref}=273 K; n is the number of stages in the additional turbine and the additional compressor; GAMMA is the adiabatic coefficient of the air; and K=6.76, L=153.6 m⁻¹·(° C.)^{-1/2}·(rev/min)⁻¹, M=421 mm·(° C.)^{1/2} and N₁=−21 millimetres (mm);
the propulsion system further comprises an additional turbine configured to drive a compressor by means of an additional shaft, the additional shaft being configured to revolve at a higher speed than the drive shaft about the axis of rotation, a mean radius of the bore of the additional turbine being at least equal to:

$${R}_{m \_ a} \geq G * F N * B P R * 1 {0}^{- 4} + H$$

where: R_{m_a} is the mean radius of the bore of the additional turbine in millimetres (mm); FN is the thrust of the fan rotor measured when the propulsion system is stationary, at take-off speed, in a standard atmosphere and at sea level and is expressed in newtons (N); BPR is the bypass ratio of the propulsion system and is measured when the propulsion system is stationary, at take-off speed, in a standard atmosphere and at sea level; and G=0.16 millimetres per newton (mm/N) and H=18 millimetres (mm);
the propulsion system further comprises an additional turbine configured to drive a compressor by means of an additional shaft, the additional shaft being configured to revolve at a higher speed than the drive shaft about the axis of rotation, a mean radius of the bore of the high-pressure turbine being at most equal to:

$${R}_{m \_ a} \leq I * FN * B P R * 1 {0}^{- 4} + J$$

where: R_{m_a} is the mean radius of the bore of the additional turbine in millimetres (mm); FN is the thrust of the fan rotor measured when the propulsion system is stationary, at take-off speed, in a standard atmosphere and at sea level and is expressed in newtons (N); BPR is the bypass ratio of the propulsion system and is measured when the propulsion system is stationary, at take-off speed, in a standard atmosphere and at sea level; and I=0.16 millimetres per newton (mm/N) and J=28 millimetres.

According to a fourth aspect, a method is proposed for manufacturing an aeronautical propulsion system comprising the following steps:
dimensioning the aeronautical propulsion system in accordance with the dimensioning method according to the third aspect; and
manufacturing the aeronautical propulsion system.

### DESCRIPTION OF THE FIGURES

Other features, aims and advantages will emerge from the following description, which is given purely by way of illustration and not being limiting and which should be read with reference to the attached drawings, in which:

FIG. 1 is a schematic, partial, sectional view of an example of a propulsion system according to a first embodiment, in which the fan section is ducted;

FIG. 2 is a schematic, partial, sectional view of an example of a propulsion system according to a first embodiment, in which the fan section is unducted;

FIG. 3 is a schematic sectional view of an example of a reduction mechanism according to a first alternative;

FIG. 4 is a schematic sectional view of an example of an epicycloidal reduction mechanism according to a second alternative;

FIG. 5 is an example of an aircraft which can comprise at least one propulsion system in accordance with the first or second embodiment;

FIG. 6 is a flow diagram illustrating examples of steps in a dimensioning or manufacturing process in accordance with one embodiment.

In all figures, similar elements have identical reference signs.

### DETAILED DESCRIPTION

A propulsion system 1 has a main direction extending along a longitudinal axis X and comprises, from upstream to downstream in the direction of gas flow in the propulsion system 1 when it is in operation, a fan section 2 and a primary spool 3, often referred to as a “gas generator”, comprising a compressor section 4, 5, a combustion chamber 6 and a turbine section 7, 8. Here, the propulsion system 1 is an aeronautical propulsion system 1 configured to be fixed to an aircraft 100 by means of a pylon (or mast).

The compressor section 4, 5 comprises a succession of stages each comprising a moving blade wheel (rotor) 4a, 5a rotating in front of a fixed vane wheel (stator) 4b, 5b. The turbine section 7, 8 also comprises a succession of stages each comprising a fixed vane wheel (stator) 7b, 8b behind which a moving blade wheel (rotor) 7a, 8a rotates.

In the present application, the axial direction corresponds to the direction of the longitudinal axis X, in correspondence with the rotation of the shafts of the gas generator, and a radial direction is a direction perpendicular to this axis X and passing through it. On the other hand, the circumferential (or lateral, or tangential) direction corresponds to a direction perpendicular to the longitudinal axis X and not passing through it. Unless specified otherwise, inner (respectively, interior) and outer (respectively, exterior), respectively, are used with reference to a radial direction such that the inner part or face of an element is closer to the axis X than the outer part or face of the same element.

In operation, an airflow F entering the propulsion system 1 is divided into a primary airflow F1 and a secondary airflow F2, which flow from upstream to downstream in the propulsion system 1.

The secondary airflow F2 (also known as the “bypass airflow”) flows around the primary spool 3. The secondary air flow F2 cools the periphery of the primary spool 3 and is used to generate most of the thrust provided by the propulsion system 1.

The primary air flow F1 flows in a primary duct inside the primary spool 3, passing successively through the compressor section 4, 5, the combustion chamber 6 where it is mixed with fuel to act as an oxidant, and the turbine section 7, 8. The passage of the primary air flow F1 through the turbine section 7, 8 receiving energy from the combustion chamber 6 causes a rotation of the rotor of the turbine section 7, 8, which in turn rotates the rotor of the compressor section 4, 5 and a rotor part 9 of the fan section 2.

In a twin-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is rotated by the high-pressure turbine 7 by means of a high-pressure shaft 10. The rotor of the low-pressure compressor 4 and the rotor part 9 of the fan section 2 are rotated by the low-pressure turbine rotor 8 by means of a low-pressure shaft 11. Thus, the primary spool 3 comprises a high-pressure spool including the high-pressure compressor 5, the high-pressure turbine 7 and the high-pressure shaft 10, and a low-pressure spool including the fan section 2, the low-pressure compressor 4, the low-pressure turbine 8 and the low-pressure shaft 11. The rotation speed of the high-pressure spool is higher than the rotation speed of the low-pressure spool. In a triple-spool propulsion system 1, the turbine section 7, 8 further comprises an intermediate turbine, positioned between the high-pressure turbine 7 and the low-pressure turbine 8 and configured to drive the rotor of the low-pressure compressor 4 by means of an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a section of its length, in the high-pressure shaft 10 and is coaxial with the high-pressure shaft 10. The low-pressure shaft 11 and the high-pressure shaft 10 can be co-rotating, i.e. driven in the same direction about the longitudinal axis X. Alternatively, the low-pressure shaft 11 and the high-pressure shaft can be counter-rotating, i.e. driven in opposite directions about the longitudinal axis X. Where applicable, the intermediate shaft is housed between the high-pressure shaft 10 and the low-pressure shaft 11. The intermediate shaft and the low-pressure shaft 11 can be co-rotating or counter-rotating.

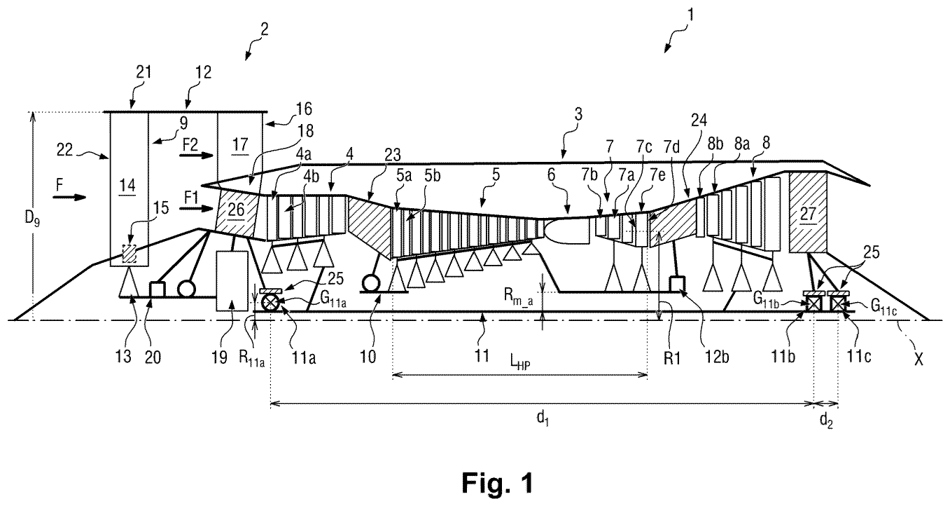

The fan section 2 comprises at least one fan rotor 9 able to be rotated relative to a stator part of the propulsion system by the turbine section 7, 8. Each fan rotor 9 comprises a hub 13 and blades 14 extending radially from the hub 13. The blades 14 of each rotor 9 can be fixed with respect to the hub 12 or have a variable pitch. In this case, the root of the blades 14 of each rotor 9 is pivotally mounted along a pitch axis and is connected to a pitch change mechanism 15 mounted in the propulsion system 1, the pitch being adjusted as a function of the flight phases by a pitch change mechanism 15. The pitch change mechanism 15 is illustrated as broken lines in FIG. 1 to indicate that this feature is optional.

The fan section 2 may further comprise a fan stator 16, or flow straightener, which comprises vanes 17 mounted on a hub 18 of the fan stator 16, and have the function of straightening the secondary airflow F2 which flows out of the fan rotor 9. The vanes 17 of the fan stator 16 can be fixed with respect to the hub 18 or have a variable pitch. In a similar way to the rotor blades 14, the root of the stator vanes 17 is pivotally mounted along a pitch axis X and is connected to a pitch change mechanism 15a, which is generally separate from that of the fan rotor 9, the pitch being adjusted as a function of the flight phases by the pitch change mechanism.

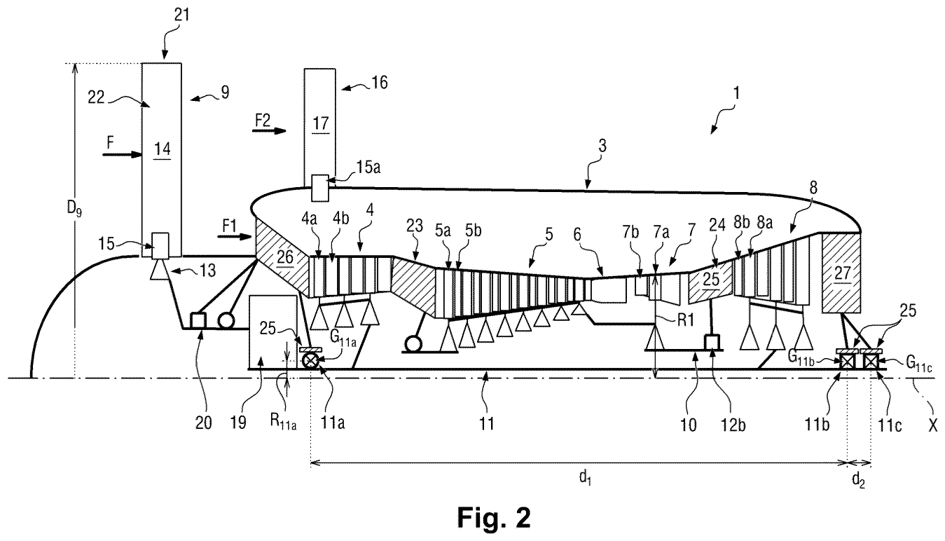

The diameter D₉ of the fan rotor can thus be between 80 inches (203.2 cm) and 185 inches (469.9 cm) inclusive. When the fan rotor 9 is ducted, the diameter D₉ is for example between 85 inches (215.9 cm) and 120 inches (304.8 cm) inclusive, for example of order 90 inches (228.6 cm), which enables the integration of the propulsion system 1 in a conventional manner, in particular under the wing of an aircraft. When the fan rotor 9 is unducted, the diameter D₉ is for example greater than or equal to 100 inches (254 cm), for example between 120 inches (304.8 cm) and 156 inches (396.2 cm). Here, the diameter of the fan rotor 9 is measured in a plane normal to the axis X of rotation at an intersection between a tip 21 and a leading edge 22 of the blades 14 of the fan rotor 9, and is expressed in metres. Note that FIGS. 1 and 2 being partial views, the diameter D₉ is only partially visible.

Furthermore, the fan rotor 9 comprises at least twelve blades 14 and at most twenty-four blades 14, for example at least sixteen blades 14 and at most twenty-two blades 14. The number of vanes 16 in the fan stator 17 depends on the acoustic criteria defined for the propulsion system 1 and is at least equal to the number of blades 14.

In order to improve the propulsion efficiency of the propulsion system 1 and to reduce its specific consumption and the noise emitted by the fan section 2, the propulsion system 1 has a high bypass ratio. The term “high bypass ratio” shall mean a bypass ratio greater than or equal to 10, for example between 10 and 80 inclusive. To calculate the bypass ratio, the mass flow rate of the secondary air flow F2 and the mass flow rate of the primary air flow F1 are measured when the propulsion system 1 is stationary, uninstalled, at take-off speed, in a standard atmosphere (as defined by the International Civil Aviation Organisation (ICAO) manual, Doc 7488/3, 3^{rd} edition) and at sea level (so-called SLS conditions, for Seal Level Standard). It should be noted that, in the present application, unless indicated otherwise, the parameters (pressure, flow, thrust, speed, etc.) are systematically determined under these conditions. The term “uninstalled” is used here to mean that the measurements are carried out when the propulsion system 1 is on a test bench (and not installed on an aircraft 100), in which case the measurements are simpler to carry out. On the other hand, the distances (length, radius, diameter, etc.) are measured at ambient temperature (approximately 20° C.) when the propulsion system 1 is cold, i.e. when the propulsion system has been stationary for a sufficient period of time for the parts of the propulsion system to be at ambient temperature.

The fan rotor 9 is decoupled from the low-pressure shaft 11 by means of a reduction mechanism 19, placed between an upstream end of the low-pressure shaft 11 and the fan rotor 9, in order to independently optimise their respective rotation speed. In this case, the propulsion system 1 also includes an additional shaft, referred to as the fan shaft 20. The low-pressure shaft 11 connects the low-pressure turbine 8 to an input of the reduction mechanism 19, while the fan shaft 20 connects the output of the reduction mechanism 19 to the fan rotor 9. The fan rotor 9 is therefore driven by the low-pressure shaft 11 via the reduction mechanism 19 and the fan shaft 20, at a rotation speed less than the rotation speed of the low-pressure turbine 8.

This decoupling makes it possible to reduce the rotation speed and the pressure ratio of the fan rotor 9 and to increase the power extracted by the low-pressure turbine 8. The overall efficiency of propulsion systems is determined to first order by the propulsion efficiency, which is favourably influenced by minimising the variation in kinetic energy of the air as it passes through the propulsion system 1. In a propulsion system 1 with a high bypass ratio, most of the flow generating the propulsive force is made up of the secondary air flow F2 of the propulsion system 1, the kinetic energy of the secondary air flow F2 being mainly affected by the compression to which the secondary air flow F2 is subjected as it passes through the fan section 2. Propulsion efficiency and the pressure ratio of the fan section 2 are therefore linked: the lower the pressure ratio of the fan section 2, the better will be the propulsion efficiency. In order to optimise the propulsion efficiency of the propulsion system 1, the fan pressure ratio, which corresponds to the ratio between the average pressure at the outlet of the fan stator 17 (or, in the absence of a stator, of the fan rotor 9) and the average pressure at the inlet of the fan rotor 9, is less than or equal to 1.70, for example less than or equal to 1.50, for example between 1.05 and 1.45. The average pressures are measured here over the height of the blade 14 (from the surface which radially delimits the internal flow duct of the fan rotor 9 to the tip 21 of the fan blade 14).

The propulsion system 1 is configured to deliver a thrust of between 18,000 lbf (80,068 N) and 51,000 lbf (222,411 N), for example between 20,000 lbf (88,964 N) and 35,000 lbf (155,688 N).

The fan section 2 may be ducted or unducted. In the case of a ducted fan section 2, the fan section 2 comprises a fan casing 12 and the fan rotor 9 is housed in the fan casing 12.

A ducted fan section 2 comprises a fan rotor 9 extending upstream of a fan stator. The stator vanes of the fan are generally referred to as outlet guide vanes (OGV) and have a fixed pitch with respect to the hub of the fan stator. Furthermore, the bypass ratio of the propulsion system 1 is, for example, greater than or equal to 10, for example between 10 and 35 inclusive, for example between 10 and 18 inclusive. The peripheral speed at the tip 21 of the blades of the fan rotor 9 can furthermore be between 260 m/s and 400 m/s. The blades 14 of the fan rotor 9 may be fixed or have a variable pitch. The fan pressure ratio can then be between 1.20 and 1.45.

In an unducted fan section 2, the fan section 2 is not surrounded by a fan casing. As the fan section 2 is unducted, the blades 14 of the fan rotor 9 have a variable pitch. Propulsion systems comprising at least one unducted fan rotor 9 are known as “open rotor” or “unducted fan”. The propulsion system 1 may comprise two unducted and counter-rotating fan rotors 9. Such a propulsion system 1 is known by the acronym CROR for “Contra-Rotating Open Rotor” or UDF for “Unducted Double Fan”. The fan rotor or rotors 9 can be positioned at the rear of the primary spool 3 so as to be of the pusher type, or at the front of the primary spool 3 so as to be of the tractor type. Alternatively, the propulsion system 1 may comprise a single unducted fan rotor 9 and an unducted fan stator 16 (flow straightener). Such a propulsion system 1 is known by the acronym USF for “Unducted Single Fan”. In the case of a propulsion system 1 of the USF type, the vanes 17 of the flow straightener 16 are fixed in rotation with respect to the axis X of rotation of the upstream fan rotor 9 and are therefore not subject to centrifugal force. The blades 17 of the flow straightener 16 also have variable pitch.

Eliminating the fairing around the fan section 2 makes it possible to increase the bypass ratio very significantly without the propulsion system 1 being penalised by the mass of the casings or nacelles designed to surround the fan section 2. The bypass ratio of the propulsion system 1 comprising an unducted fan section 2 is thus greater than or equal to 40, for example between 40 and 80 inclusive. The peripheral speed at the tip 21 of the blades 14 of the fan rotor or rotors 9 can also be between 210 m/s and 260 m/s. The fan pressure ratio can then be between 1.05 and 1.20, for example.

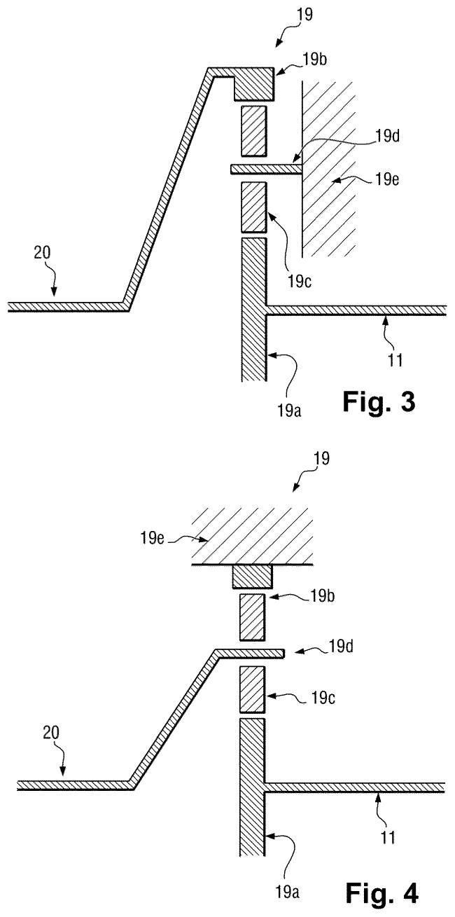

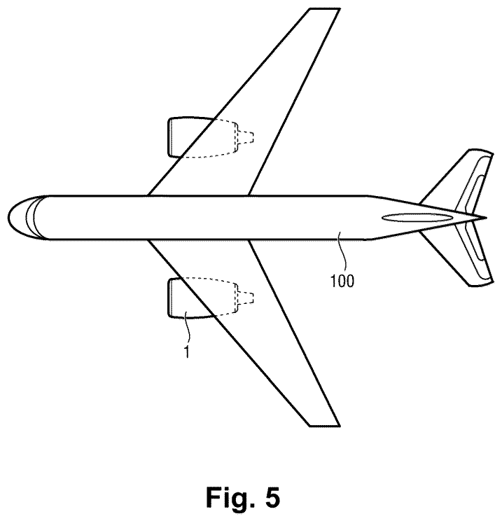

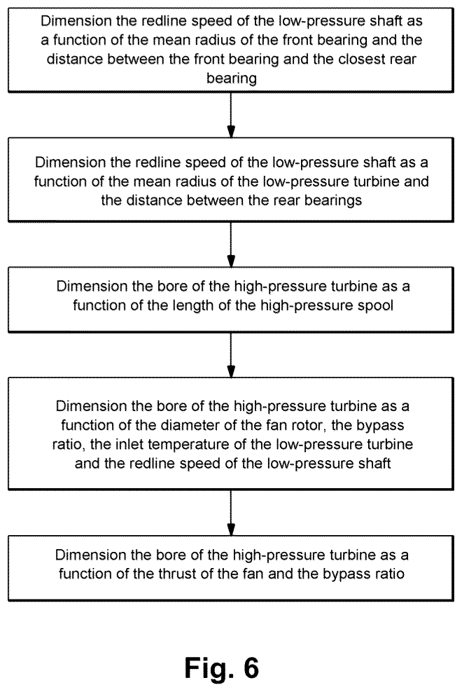

The reduction mechanism 19 may comprise, for example, a reduction mechanism with an epicycloidal gear train, for example of the “epicycloidal” or “planetary” type according to the terminology sometimes encountered by a person skilled in the art, single-stage or two-stage. According to a first alternative, the reduction mechanism 19 can be of the “star” type (FIG. 3) and comprises a sun gear 19a (input of the reduction mechanism 19), centred on an axis X of rotation of the reduction mechanism 19 (generally coincident with the longitudinal axis X) and configured to be rotated by the low-pressure shaft 11, a ring gear 19b (output of the reduction mechanism 19) coaxial with the sun gear 19a and configured to drive the fan shaft 20 in rotation about the axis X of rotation, and a series of planets 19c distributed circumferentially about the axis X of rotation between the sun gear 19a and the ring gear 19b, each planet 19c being meshed internally with the sun gear 19a and externally with the ring gear 19b. The series of planets 19c is mounted on a planet carrier 19d which is fixed relative to a stator part 19e of the propulsion system 1, for example relative to a casing of the compressor section 4, 5. According to a second variant, the reduction mechanism 19 may be of the planetary type (FIG. 4), in which case the ring gear 19b is fixedly mounted on the stator part 19e of the propulsion system 1 and the fan shaft 20 is rotated by the planet carrier 19d (which is therefore rotatable relative to a stator part 19e of the propulsion system 1, for example relative to a casing of the compressor section 4, 5).

Whatever the configuration of the reduction mechanism 19, the diameter of the ring gear 19b and the planet carrier 19d are greater than the diameter of the sun gear 19a, so that the rotation speed of the fan rotor 9 is lower than the rotation speed of the low-pressure shaft 11.

The reduction ratio of the reduction mechanism 19 is greater than or equal to 2.5 and less than or equal to 11. In the case of a propulsion system 1 comprising a ducted fan rotor 9, the reduction ratio may be greater than or equal to 2.7 and less than or equal to 6.0, typically around 3.0. In the case of a propulsion system 1 comprising an unducted fan rotor, the reduction ratio may be between 9.0 and 11.0.

The low-pressure shaft 11 is supported by three or four bearings 11a, 11b and/or 11c, in order to better control the deformation modes of the low-pressure shaft 1 and optionally to move the deformation modes of the low-pressure shaft 11 into the transient regime of the propulsion system 1, with safety margins in relation to the steady-state regimes.

The Applicant has realised that the position of the bearings 11a-11c of the low-pressure shaft 11 could have an influence on the deformation modes of the low-pressure shaft 11. The low-pressure shaft may thus comprise one or two front bearings 11a, which extend upstream of the combustion chamber 6, and two rear bearings 11b, 11c which extend downstream of the combustion chamber 6. A first front bearing 11a can be mounted, on the one hand, on the low-pressure shaft 11 and, on the other hand, on an inlet casing 26 of the propulsion system 1, which extends between the fan rotor 9 and the low-pressure compressor 4. Where appropriate, a second front bearing can be mounted, on the one hand, on the low-pressure shaft 11 and, on the other hand, on an inter-compressor casing 23 (or intermediate casing) of the propulsion system 1, i.e. between the low-pressure compressor 4 and the high-pressure compressor 5. A first rear bearing 11b can be mounted, on the one hand, on the low-pressure shaft 11 and, on the other hand, on the inter-turbine casing 24 (i.e. on the casing extending between the high-pressure turbine 7 and the low-pressure turbine 8), upstream of the low-pressure turbine 8. Alternatively, the first rear bearing 11b can be mounted on the exhaust casing 27, which extends immediately downstream of the low-pressure turbine 8. The first rear bearing 11b extends downstream of the furthest downstream bearing 12b of the high-pressure shaft 10. The second rear bearing 11c may be mounted on the exhaust casing 27. Where appropriate, the first and second rear bearings 11b, 11c may be mounted on the same cylindrical sleeve, which is itself fixed to the exhaust casing 27.

The inlet casing 26, the intermediate casing 23, the exhaust casing 27 and, where applicable, the inter-turbine casing 24 form the structural casings of the propulsion system 1, through which the forces generated by the propulsion system 1 pass.

The decoupling of the low-pressure shaft 11 and the fan rotor 9 by the reduction mechanism 19 results in an efficient propulsion system 1 for which the fan pressure ratio is less than 1.45. As a result, the amount of energy required to drive the fan rotor 9 is reduced so that the inlet flow to the high-pressure compressor 5, and therefore the inlet cross-section of the high-pressure compressor 5, can be reduced. However, this has the consequence of limiting the space available for the low-pressure shaft 11 (since the low-pressure shaft 11 is housed within the high-pressure shaft 10). In addition, reducing the flow rate in the high-pressure compressor 5 also has the effect of reducing the flow rate in the low-pressure turbine 8, which increases the rotation speed of the low-pressure shaft 11 and reduces the torque transmitted by the low-pressure shaft 11 and its diameter. However, reducing the diameter of the low-pressure shaft 1 makes it necessary to optimise the dynamic behaviour of the low-pressure shaft 11 to prevent it from becoming more supercritical.

In order to optimise the propulsion system 1 while controlling the dynamic behaviour of the low-pressure shaft 11, the propulsion system 11 is dimensioned so that a redline speed of the drive shaft 11 satisfies the following formula:

$$X N \geq A * \frac{{R}_{11 b}}{{d}_{1}^{2}} * 1 {0}^{5} \qquad ( 1 )$$

where: XN is the redline speed of the drive shaft (11), in revolutions per minute (rev/min);
R_{11b} is a mean radius of the rear bearing 11b closest to the front bearing 11a, in millimetres (mm); and
d₁ is a distance between a centre of gravity G₁₁ₐ of the front bearing 11a and a centre of gravity G_{11b} of the rear bearing 11b closest to the front bearing 11a, in millimetres (mm; and
A=5500 mm*rev/min.

The redline speed XN corresponds to the absolute maximum speed able to be encountered by the low-pressure shaft 11 throughout the flight ((according to European certification regulation EASA CS-E 740 (or according to American certification regulation 14-CFR Part 33)). The redline speed corresponds to the maximum rotation speed when the propulsion system is healthy (and potentially at end-of-life). It is therefore likely to be reached by the low-pressure shaft 11 under flight conditions. This redline speed is part of the data declared in the engine certification (“type certificate data sheet”). In fact, this rotation speed is usually used as a reference speed for dimensioning propulsion systems 1 and in certain certification tests (such as blade loss or rotor integrity tests).

The mean radius R_{11b} of the rear bearing 11b (and respectively R₁₁ₐ of the front bearing 11a) corresponds to the distance, measured in a plane normal to the longitudinal axis X, between the axis X and the centre of gravity G_{11b} of the rear bearing 11b closest to the front bearing 11a, i.e. the furthest upstream (and respectively the centre of gravity G₁₁ₐ of the rear bearing 11a). It should be noted here that a bearing comprises an outer ring and an inner ring which are coaxial, as well as rolling elements (balls, rollers, etc.) mounted between the inner ring and the outer ring and configured to allow relative movement of the inner ring with respect to the outer ring. The inner ring is mounted on the low-pressure shaft 11 and rotated by the low-pressure shaft 11; the outer ring is mounted on a stator part (inlet casing 26, inter-compressor casing 23, inter-turbine casing 24, exhaust casing 27, etc.) of the propulsion system 1. The centre of gravity of a bearing then corresponds to the centre of gravity of the assembly formed by the inner ring, the outer ring and the rolling elements. When the inner ring and/or the outer ring are formed integrally and in a single piece with a support (flange, shroud, enclosure, etc.) of the propulsion system 1 so that the ring cannot be distinguished from the support, the centre of gravity is determined without taking into account the ring in question.

When the low-pressure shaft is supported by two front bearings upstream of the combustion chamber, the distance d₁ is measured between the front bearing 11a closest to the combustion chamber 6 (i.e. the front bearing 11a furthest downstream) and the rear bearing 11b closest to the combustion chamber 6 (i.e. the rear bearing 11b furthest upstream). In other words, the distance d₁ corresponds to the smallest distance between the centres of gravity of the front bearings 11a and the rear bearings 11b.

When the redline speed XN satisfies formula (1), the redline speed is sufficiently high to ensure that the first deformation mode of the low-pressure shaft 11 is in a rotation speed range of the low-pressure shaft 11 in which the dynamic situation of the low-pressure shaft 11 can be controlled. Typically, for a propulsion system comprising a reduction mechanism 19, the first deformation mode of the low-pressure shaft 11 occurs at a transient speed corresponding, for example, to a speed less than the idle speed and is therefore not likely to damage the propulsion system 1. Hence, a transient speed is selected which only occurs for a very short time in the operation of the propulsion system 1. For example, the propulsion system is dimensioned so that the critical speed corresponds to a speed occurring only at the beginning of start-up or at the end of shut-down of the propulsion system 1, such as a speed less than idle speed or greater than idle speed but outside a regular operating range or in a transient operating range that is very infrequently used during operation of the propulsion system 1. The low-pressure shaft 11 therefore remains supercritical but its dynamic situation is under control.

For example, the redline speed XN likewise satisfies the following formula:

$$X N \leq B * \frac{{R}_{11 a}}{{d}_{1}^{2}} * 1 {0}^{5} \qquad ( 2 )$$

$$where B = 8500 mm * rev / min .$$

When the low-pressure shaft 11 does not comply with formula (2), its critical speed becomes too high and involves mechanical and dimensioning constraints that are difficult to control.

The redline speed XN of the low-pressure shaft 11 can typically be between 8500 revolutions per minute and 12,000 revolutions per minute, for example between 9000 revolutions per minute and 11,000 revolutions per minute.

The redline speed XN of the low-pressure shaft 11 can be modified by acting on the following elements of the propulsion system 1:

1. The shaft geometry (outer and inner diameters). The outer diameter of the low-pressure shaft has an impact on the design of the high-pressure casing, since the low-pressure shaft 11 passes through the high-pressure shaft 10 and constrains the bore radius of the high-pressure turbine 7. Moreover, variations in the internal shape enabling an increase in the critical speed of the low-pressure shaft 11 are limited by the manufacturing constraints of the low-pressure shaft 11.

2. The material of the low-pressure shaft 11 (effect of the Young's modulus/density ratio). Conventionally, steels are used having small variations in Young's modulus. Alternatively, the low-pressure shaft 11 can also be made from metal matrix composite materials, which have a much higher Young's modulus/density ratio but a lower capacity to transmit torque at the interfaces than conventional steels.

3. The number and position of the bearings 11a-11d of the low-pressure shaft 11. An architecture in which the low-pressure shaft 11 is supported by four bearings increases the critical speed XN of the low-pressure shaft 11. However, the addition of a bearing compared with a three-bearing configuration increases the difficulties of integration. Where appropriate, the rear bearings of the low-pressure shaft 11 can be integrated upstream of the low-pressure turbine 8, which increases the critical speed XN of the low-pressure shaft 11 at the expense of the engine length.

4. The stiffness of the journals between the rotors of the low-pressure casing. Increasing the stiffness of the journals increases the critical speed XN of the low-pressure shaft 11. However, increasing the stiffness of the journals also increases the difficulties for design and integration.

In the case of propulsion systems with a high bypass ratio (BPR) and a high overall pressure ratio (OPR), the outer diameter of the low-pressure shaft 11 and the distance between the low-pressure bearings are strongly constrained by the integration of the high-pressure spool, which leads to a supercritical dynamic situation that must be controlled. Dimensioning the redline speed XN in such a way as to comply with formulas (1) and (2) therefore makes it possible to optimise the integration of the high-pressure spool while remaining within accessible ranges for the other parameters mentioned above. Moreover, in order to avoid the length penalty associated with the integration of bearings for the low-pressure shaft upstream of the low-pressure turbine, an adjustment of the distance d₂ between the centres of gravity of the two rear bearings 11b, 11c of the low-pressure shaft 11 in accordance with formulas (3) and (4) (see below) makes it possible to obtain the desired dynamic situation.

Where appropriate, in order to further improve control of the supercriticality of the low-pressure shaft 11, the bearings 11a-11c of the low-pressure shaft 11 comprise a bearing mode damper 25 comprising a pressurised oil film configured to damp the mode transition (viscous damping). This type of damping is generally known as “squeeze film” damping. The bearings can also comprise a flexible cage, mounted between the outer ring and a rigid support fixed to a stator part (inlet casing 26, inter-compressor casing 23, inter-turbine casing 24, exhaust casing 27, etc.) of the propulsion system 1, in order to control the stiffness of the bearings and to fine-tune the position of the first deformation mode. For this purpose, the cage comprises a generally cylindrical wall mounted between the rigid support and the outer ring of the bearing and radially deformable studs so as to allow radial displacement of the generally cylindrical wall and therefore of the bearing 11a-11c with respect to the rigid support. Examples of bearings with a flexible cage and a pressurised fluid film damper comprising a flexible cage are described in WO 2021/001610 and WO 2022/195198 in the name of the Applicant. The damping of the response of the low-pressure shaft 11 using these bearing mode dampers 25 can thus limit the resonance of the low-pressure shaft when its frequency reaches the first deformation mode.

In one embodiment, in order to further improve control of the dynamics of the low-pressure shaft 11, the low-pressure shaft 11 is also dimensioned taking into account the radial position and the embedding of the rear bearings 11b, 11c of the shaft 11. The further apart the rear bearings 11b, 11c are and/or the further the rear bearings 11b, 11c are from the axis X, the more the rear bearings 11b, 11c are embedded and therefore the stiffer the low-pressure shaft 11.

Thus, to increase the embedding of the low-pressure shaft 11 and further improve its dynamics, the limiting speed also satisfies the following formula:

$$X N \geq \frac{1}{C} * \frac{{R}_{11 b}}{{d}_{1}^{2}} * 1 {0}^{5} * ( \frac{{R}_{m}}{{d}_{2}} * 1000 - {E}_{1} ) \qquad ( 3 )$$

where: Rₘ is a mean radius of the low-pressure turbine 8, in millimetres (mm);
d₂ is the distance between the centres of gravity of the rear bearings 11b, 11c of the low-pressure shaft 11, in millimetres (mm); and
C=0.17 (mm*rev/min)⁻¹, E₁=378.

For example, the redline speed likewise satisfies the following formula:

$$XN \leq \frac{1}{C} * \frac{{R}_{11 b}}{{d}_{1}^{2}} * 1 {0}^{5} ( \frac{{R}_{m}}{{d}_{2}} * 1000 + {E}_{2} ) \qquad ( 4 )$$

where: E₂=180. When the low-pressure shaft 11 does not comply with formula (4), its critical speed becomes too high and involves mechanical and dimensioning constraints that are difficult to control.

The mean radius Rₘ of the low-pressure turbine 8 corresponds to the arithmetic mean of the mean radii of the rotors 8a (moving blade wheels) of the low-pressure turbine 8. In a given stage, the mean radius R1 of a rotor 8a corresponds to the arithmetic mean between the outer radius of the rotor 8a and the inner radius of the rotor 8a, where the outer radius and the inner radius are measured between the axis of rotation X and the inner radial surface of the rotor 8a (which radially delimits the blade of the rotor 8a on the inside), when the propulsion system 1 is cold. Note that the outer radius and the inner radius are both measured in a plane normal to the axis of rotation X of the low-pressure turbine 8, halfway between the leading edge 8c at the tip of the moving blades and the trailing edge 8d at the tip of the moving blades (i.e. at 50% of the blade tip chord), between the axis of rotation X and the radial outer surface of the rotor 8a (which delimits the rotor blade 8a radially on the outside).

In the case where the low-pressure shaft 11 is supported by exactly two rear bearings 11b, 11c (and one or two front bearings 11a), the distance d₂ is measured between the centres of gravity G_{11b} and G_{11c} of these two bearings 11b and 11c. When the low-pressure shaft 11 is supported, in addition to the front bearing or bearings 11a, by exactly three rear bearings, the distance d₂ is measured between the bearing furthest upstream and the bearing furthest downstream of the rear bearings.

The low-pressure shaft 11 being housed in the high-pressure shaft 10, its diameter is constrained by the mean radius R_{m_a} of the bore of the high-pressure turbine 7. The larger the diameter of the low-pressure shaft 11, the more its natural modes appear at higher rotation speeds (or, in other words, the more the deformation modes of the shaft are shifted towards higher frequencies). Optionally, in order to obtain a compromise between a mean bore radius of the high-pressure turbine 7 of small diameter-which makes it possible to improve the overall pressure ratio of the propulsion system and its bypass ratio BPR—while controlling the dynamic situation of the low-pressure shaft 11, the mean radius R_{m_a} of a bore of the high-pressure turbine 7 may comply with the following formula, in particular when the fan section 2 is ducted:

$${R}_{m\_a} \leq E * {L}_{HP}^{2} * XN * 1 {0}^{- 9} + {F}_{1} \qquad ( 5 )$$

where: R_{m_a} is expressed in millimetres (mm);
L_{HP} is the length of the high-pressure spool, in millimetres (mm);
E=3.15 (mm.rev/min)⁻¹ and F₁=23 millimetres (mm).

Indeed, as we have seen above, the deformation frequency of the low-pressure shaft 11 is proportional to the ratio between the diameter of the low-pressure shaft 11 and the square of the distance (d₁₂) between the bearings 11a-11b of the low-pressure shaft 11. Thus, the further apart the bearings 11a-11b supporting the low-pressure shaft 11, the lower the deformation frequency (and therefore the deformation modes) of the low-pressure shaft 11. The position of the bearings 11a-11b of the low-pressure shaft 11 depends on the length of the high-pressure spool. By defining the mean radius R_{m_a} of the bore of the high-pressure turbine 7 as a function of the length of the high-pressure spool L_{HP} (which is formed by the high-pressure compressor 5 and the high-pressure turbine 7), the dynamic behaviour of the low-pressure shaft 11 can therefore be better controlled.

For example, the mean radius R_{m_a} of the bore of each disc of the high-pressure turbine 7 satisfies formula (5).

A propulsion system 1 for which the mean radius R_{m_a} of the bore of the high-pressure turbine 7 satisfies formula (5), can then achieve an overall pressure ratio, which corresponds to the pressure ratio between the outlet pressure of the high-pressure compressor 5 and the inlet pressure of the fan rotor 9 (measured at the root of the fan rotor 9), being greater than or equal to 40 and less than or equal to 70, for example greater than or equal to 44 and less than or equal to 55.

The rotation speed of the high-pressure turbine 7 can then be between 15,000 revolutions per minute and 27,000 revolutions per minute. When the rotation speed of the high-pressure turbine (and therefore of the high-pressure shaft 10) is within this range and its mean radius R_{m_a} satisfies formula (4), the mechanical loading of the rotors 7a is acceptable for the high-pressure turbine 7.

The length of the high-pressure spool L_{HP} may, for example, be between 950 mm and 1450 mm for a high-pressure spool comprising between ten and thirteen compressor and turbine stages.

The mean radius R_{m_a} of a bore in the high-pressure turbine 7 may also comply with the following formula, in particular when the fan section 2 is ducted:

$${R}_{m\_a} \leq E * {L}_{HP}^{2} * XN * 1 {0}^{- 9} + {F}_{2} \qquad ( 6 )$$

where: F₂=13 millimetres (mm).

The dimensioning of the mean radius of the bore to comply with formula (6) ensures a minimum radius for the high-pressure turbine and therefore guarantees its ability to withstand centrifugal forces

In some cases, the mean radius of the bore R_{m_a} of the high-pressure turbine 7 is dimensioned before the length of the high-pressure casing L_{HP} can be determined. In this case, the mean radius of the bore can be determined from the fundamental dimensioning parameters which are the diameter Dg of the fan rotor 9, the bypass ratio BPR of the propulsion system 1 or the redline speed XN of the low-pressure shaft 11, rather than the length of the high-pressure spool (as defined in formulas (5) and (6):

$${R}_{m\_a} \leq K * {( L * \sqrt{\frac{{D}_{9}^{2}}{BPR + 1} * {( {T}_{e} + {T}_{ref} )}^{05 - \frac{GAMMA}{GAMMA - 1}} * 1 {0}^{3}} * n + M )}^{2} * XN * 1 {0}^{- 9} + {N}_{1} \qquad ( 7 )$$

where: BPR is the bypass ratio of the propulsion system 1, in pounds of thrust;

D₉ is the diameter of the fan rotor 9 in millimetres (mm), measured in a plane normal to the axis of rotation (X) at an intersection between a tip 21 and a leading edge 22 of the blades 14 of the fan rotor (9);
Tₑ is the temperature at the inlet of the low-pressure turbine 8, in degrees Celsius;
T_{ref}=273 K;
n is the number of stages in the high-pressure casing (i.e. in the high-pressure turbine 7 and in the high-pressure compressor 5);
GAMMA is the adiabatic coefficient of the air;
K=6.76, L=153.6 m⁻¹·(° C.)^{-1/2}·(rev/min)⁻¹, M=421 mm·(° C.)^{1/2} and N₁=−11 millimetres (mm).

As stated for formula (6), when the mean radius of the bore R_{m_a} of the high-pressure turbine 7 satisfies formula (7), the dynamic behaviour of the low-pressure shaft 11 can therefore be better controlled.

For example, the mean radius R_{m_a} of the bore of each disc of the high-pressure turbine 7 satisfies formula (7).

Moreover, the mean radius of the bore can also comply with the following formula:

$${R}_{{m}_{a}} \geq K * {( L * \sqrt{\frac{{D}^{2}}{BPR + 1} * {( {T}_{e} + {T}_{ref} )}^{05 - \frac{GAMMA}{GAMMA - 1}} * 1 {0}^{3}} * n + M )}^{2} * XN * {10}^{- 9} + {N}_{2} \qquad ( 8 )$$

where N₂=−21 millimetres (mm).

For example, the mean radius R_{m_a} of the bore of each disc of the high-pressure turbine 7 satisfies formula (8).

For example, the propulsion system 1 is also dimensioned so that the mean radius R_{m_a} of the bore of the high-pressure turbine 7 also satisfies the following formula, in particular when the fan section 2 is ducted:

$${R}_{m\_a} \leq I * FN * BPR * 1 {0}^{- 4} + J \qquad ( 9 )$$

where: FN is the thrust of the fan rotor 9, in newtons (N); and

I=0.16 millimetres per newton (mm/N) and J=28 millimetres (mm).

The torque transmitted by the low-pressure shaft 11 to the fan rotor 9 is linked to the thrust of the fan rotor 9 and to the bypass ratio BPR of the propulsion system 1. Furthermore, increasing the bypass ratio BPR of the propulsion system 1 makes it possible to reduce the diameter of the high-pressure spool, and therefore the mean radius R_{m_a} of the bore of the high-pressure turbine 7. Hence, by dimensioning the propulsion system so that the mean radius R_{m_a} of the bore of the high-pressure turbine 7 also satisfies formula (9), a propulsion system 1 is obtained in which the size of the high-pressure spool and the diameter of the low-pressure shaft 11 are dimensioned as a function of the thrust of the fan rotor 9 (which contributes the majority of the overall thrust of the propulsion system 1) and the bypass ratio BPR.

For example, the mean radius R_{m_a} of the bore of each disc of the high-pressure turbine 7 satisfies formula (9).

For example, the mean radius of the high-pressure turbine bore is at most 300 mm.

In one embodiment, in order to maintain the possibility of introducing and passing the low-pressure shaft 11 into the high-pressure shaft 10, while guaranteeing the ability of the low-pressure shaft 11 to transmit the torque required for the fan rotor 9 and the low-pressure compressor 4, the mean radius R_{m_a} of the bore of the second turbine 7 also satisfies the following formula, in particular when the fan section 2 is ducted:

$${R}_{m\_a} \geq G * FN * BPR * 1 {0}^{- 4} + H \qquad ( 10 )$$

where: G=0.16 millimetres per newton (mm/N) and H=18 millimetres (mm).

For example, the mean radius R_{m_a} of the bore of each disc of the high-pressure turbine 7 satisfies formula (10).

### Comparative Example

Engine 1 is a twin-spool propulsion system comprising a ducted fan section 2 corresponding to the current technical standard (at the date of filing of the present application) which we are seeking to improve.

Engine 2 is a two-stage propulsion system 1 comprising a ducted fan section 2 in accordance with the teachings of the present application, the drive shaft of which (i.e. here the low-pressure shaft) has a redline speed complying with the formulas (1) and (2) defined above.

Both Engine 1 and Engine 2 have a low-pressure shaft supported by exactly one bearing upstream of the combustion chamber and two bearings downstream of the combustion chamber. In addition, the front bearing is damped by a film of pressurised fluid.

| | | | Engine 2 | |
|---|---|---|---|---|
| | | | (according to the | |
| Dimensioning parameter (SLS unless | Engine 1 | | disclosure of the | |
| otherwise indicated) | (reference engine) | | present application) | |
| Average radius of the rear bearing R_{11b} | 62.6 | mm | 58.7 | mm |
| Inter-bearing distance d₁ | 1804.1 | mm | 2034.9 | mm |
| Redline speed of the low-pressure shaft (XN) | 9541 | rev/min | 10,025 | rev/min |
| $A * \frac{{R}_{11 b}}{{d}_{1}^{2}} * 1 {0}^{5}$ | 10,572 | rev/min | 7796 | rev/min |
| $B * \frac{{R}_{11 b}}{{d}_{1}^{2}} * 1 {0}^{5}$ | 16,340 | rev/min | 12,049 | rev/min |
| Diameter of the low-pressure shaft, measured | 87.2 | mm | 81.5 | mm |
| in line with the high-pressure turbine disc | | | | |
| Average radius of the low-pressure turbine Rm | 366.3 | mm | 310.9 | mm |
| Inter-bearing distance d₂ | 234.9 | mm | 229.4 | mm |
| $\frac{1}{C} * \frac{{R}_{11 b}}{{d}_{1}^{2}} * 1 {0}^{8} * ( \frac{{R}_{m}}{{d}_{2}} * 1000 - {E}_{1} )$ | 13,372.5 | rev/min | 7,882 | rev/min |
| $\frac{1}{C} * \frac{{R}_{11 b}}{{d}_{1}^{2}} * 1 {0}^{8} * ( \frac{{R}_{m}}{{d}_{2}} * 1000 + {E}_{2} )$ | 19,689.0 | rev/min | 12,383 | rev/min |
| Average bore radius of the high-pressure | 53.7 | mm | 51.5 | mm |
| turbine Rₘ_a | | | | |
| High-pressure spool length L_{HP} | 1083 | mm | 1143 | mm |
| Fan rotor diameter D₉ | 2.0574 | m | 2.2352 | m |
| Bypass ratio BPR | 12.0 | | 13.0 | |
| Temperature at the inlet of the low-pressure | 1026° C. | | 1066° C. | |
| turbine (redline) | | | | |
| Number of high-pressure compressor stages | 9 | | 10 | |
| Number of high-pressure turbine stages | 2 | | 2 | |
| Fan thrust FN | 152, 129.2 N | | 151,684.4 N | |
| Number of fan blades | 18 | | 18 | |
| Pressure ratio of the fan | 1.44 | | 1.40 | |
| Reduction ratio | 2.88 | | 3.80 | |
| Hub-tip ratio of the fan rotor | 0.30 | | 0.30 | |
| Redline speed of the fan rotor | 3316 | rev/min | 3039 | rev/min |
| High-pressure shaft redline speed | 21,178 | rev/min | 22,252 | rev/min |

| Low-pressure compressor pressure ratio | 1.85 | 3.30 |
|---|---|---|
| Overall pressure ratio | 42 | 55 |
| Number of stages of the low-pressure | 2 | 3 |
| compressor | | |
| Number of low-pressure compressor stages | 3 | 4 |
| Temperature at the inlet of the high-pressure | 1850° C. | 1930° C. |
| turbine | | |

| | | |
|---|---|---|
| N₇²S₇ | 57.6 × 10⁶ | 53.0 × 10⁶ |
| (where S₇ is the outlet cross-section of the low- | (rev/min)²·m² | (rev/min)²·m² |
| pressure turbine) | | |
| XN²S₈ | 36.4 × 10⁶ | 40.2 × 10⁶ |
| (where S₈ is the outlet cross-section of the low- | (rev/min)²·m² | (rev/min)²·m² |
| pressure turbine) | | |

The redline speed XN of the low-pressure shaft of Engine 1 is less than the minimum redline speed defined by formula (1) as a function of the radius of the upstream rear bearing R_{11b} of the low-pressure shaft and the inter-bearing distance d₁. The consequence is that the first deformation mode of the low-pressure shaft, which is supercritical, occurs at a transient speed close to take-off speed. As a result, the vibratory loads seen during the mode transition are high despite the presence of the bearing mode damper. This is confirmed by the fact that the redline speed XN of the low-pressure shaft of engine 1 does not comply with formula (4).

In comparison, the redline speed of the low-pressure shaft of Engine 2 is greater than the minimum redline speed defined by formula (1). The first deformation mode of the low-pressure shaft, which is supercritical, therefore occurs in a transient operating range closer to idle. The bearing mode damper can also damp the mode transition, given that the vibratory loads in Engine 2 are moderate in this operating range compared with the vibratory loads experienced by Engine 1. The redline speed XN also remains sufficiently high to prevent the second deformation mode from being in the operating range of Engine 2. In addition, the diameter of the low-pressure shaft is limited, despite the fact that it drives only seven stages in total (three compressor stages 4 and four turbine stages 8). Finally, the mean radius of the low-pressure turbine 8 of engine 2 is smaller than that of Engine 1, despite the larger number of stages, so that the low-pressure turbine 8 of Engine 2 is more compact radially than the low-pressure turbine of Engine 1.

The redline speed XN of the low-pressure shaft of Engine 2 also remains below the maximum redline speed defined in formula (2) to limit the vibratory loads seen when the mode is changed.

In order to move from Engine 1 (reference) to Engine 2 (according to the disclosure), the fan diameter D₉ and the bypass ratio BPR were increased, thereby improving propulsive efficiency and maintaining comparable fan thrust given the reduction in the pressure ratio of the fan section 2. Furthermore, the overall pressure ratio has been increased, as has the inlet temperature of the high-pressure turbine 7, which enables the thermal efficiency of the propulsion system 1 to be increased.

In addition, the outer diameter of the shaft of the low-pressure turbine 11 has been reduced to facilitate integration of the high-pressure spool, while respecting the mechanical dimensions of the high-pressure turbine discs.

The adjustment to obtain a critical speed of the first deformation mode of the low-pressure shaft 11 in the speed range defined by the formulas (1) to (4) was made by adapting the distance d₂ between the centres of gravity of the rear bearings of the low-pressure shaft 11 and by optimising the internal geometry of the low-pressure shaft 11 while respecting the manufacturing constraints of the shaft 11.

The number of bearings supporting the low-pressure shaft has been kept at 3 (and not increased to 4) for reasons of integration of the bearing upstream of the low-pressure shaft, given the position of the low-pressure compressor duct.

The solution of advancing one or both of the downstream bearings of the low-pressure turbine to upstream thereof was also ruled out to avoid lengthening Engine 2 and to avoid the problem of misalignment between the two bearings.

1. An aeronautical propulsion system comprising:
a fan rotor connected to a fan shaft;
a drive turbine configured to drive the fan rotor by a drive shaft about an axis of rotation;
a reduction structure that couples the drive shaft and the fan shaft in order to drive the fan shaft at a rotation speed less than the rotation speed of the drive shaft;
a plurality of bearings configured to center the drive shaft with respect to the axis of rotation, the plurality of bearings comprising a front bearing extending upstream of a combustion chamber of the propulsion system and two rear bearings extending downstream of the combustion chamber,
wherein a redline speed of the drive shaft satisfies the following formula:
$$XN \geq A * \frac{{R}_{11 b}}{{d}_{1}^{2}} * 1 {0}^{5}$$
where: XN is the redline speed of the drive shaft, in revolutions per minute;
R_{11b} is a mean radius of a rear bearing of the two rear bearing that is closest to the front bearing, in millimetres (mm); and
d₁ is a distance between a center of gravity of the front bearing and a center of gravity of the rear bearing closest to the front bearing, in millimetres; and
A=5500 mm*rev/min.

2. The propulsion system according to claim 1, wherein the redline speed of the drive shaft further satisfies the following formula:
$$\begin{matrix}XN \leq B * \frac{{R}_{11 b}}{{d}_{1}^{2}} * 1 {0}^{5} \\ - where B = 8500 {mm}^{*} rev / min .\end{matrix}$$

3. The propulsion system according to claim 1, wherein each bearing of the plurality of bearings is associated with a bearing mode damper.

4. The propulsion system according to claim 3, wherein the bearing mode dampers comprise a squeeze film.

5. The propulsion system according to claim 3, wherein the bearing mode dampers comprise a deformable cage mounted between a ring of each bearing and a stator part of the propulsion system.

6. The propulsion system according to claim 1, wherein the plurality of bearings comprise an additional front bearing extending upstream of the front bearing.

7. The propulsion system according to claim 1, wherein the redline speed of the drive shaft further satisfies the following formula:
$$XN \geq \frac{1}{C} * \frac{{R}_{11 b}}{{d}_{1}^{2}} * 1 {0}^{8} * ( \frac{{R}_{m}}{{d}_{2}} * 1000 - {E}_{1} )$$
where: Rₘ is a mean radius of the drive turbine, in millimetres;
d₂ is a distance between the centers of gravity of the two rear bearings, in millimetres; and
C=170 (mm*rev/min)⁻¹ and E₁=378.

8. The propulsion system according to claim 1, wherein the redline speed of the drive shaft further satisfies the following formula:
$$XN \leq \frac{1}{C} * \frac{{R}_{11 b}}{{d}_{1}^{2}} * 1 {0}^{8} * ( \frac{{R}_{m}}{{d}_{2}} * 1000 + {E}_{2} )$$
where: Rm is a mean radius of the drive turbine, in millimetres;
d₂ is a distance between the centers of gravity of the two rear bearings, in millimetres; and
C=170 (mm*rev/min)⁻¹ and E₂=180.

9. The propulsion system according to claim 1, wherein the plurality of bearings comprise at least one of the front bearing and exactly the two rear bearings.

10. The propulsion system according to claim 1, further comprising an additional turbine configured to drive an additional compressor by an additional shaft, the additional shaft being configured to rotate at a higher speed than the drive shaft about the axis of rotation, the additional turbine being two-stage.

11. The propulsion system according to claim 10, wherein the additional compressor comprises at least eight stages and at most eleven stages.

12. The propulsion system according claim 1, wherein a mean radius of a bore of the additional turbine is at most equal to 300 mm.

13. The propulsion system according to claim 1, wherein the drive turbine comprises at least three stages and at most five stages.

14. The propulsion system according to claim 1, wherein a reduction ratio of the reduction mechanism is greater than or equal to 2.5 and less than or equal to 11.

15. An aircraft comprising at least one of the propulsion system according to claim 1,
wherein the at least one of the propulsion system is fixed to the aircraft by a mast.

16. A method for operating a propulsion system comprising a reduction system coupling a drive shaft and a fan rotor to drive the fan rotor at a speed less than a speed of the drive shaft, and bearings configured to center the drive shaft with respect to the axis of rotation, the bearings comprising a front bearing extending upstream of a combustion chamber of the propulsion system and two rear bearings extending downstream of the combustion chamber,
the propulsion system being dimensioned so that a redline speed of the drive shaft satisfies the following formula:
$$XN \geq A * \frac{{R}_{11 b}}{{d}_{1}^{2}} * 1 {0}^{5}$$
where: XN is the redline speed of the drive shaft, in revolutions per minute;
R_{11b} is a mean radius of a rear bearing of the two rear bearings that is closest to the front bearing, in millimetres; and
d₁ is a distance between a center of gravity of the front bearing and a center of gravity of the rear bearing that is closest to the front bearing, in millimetres; and
A=5500 mm*rev/min.

17. The operating method according to claim 16, wherein the propulsion system is dimensioned such that the redline speed of the drive shaft further satisfies the following formula:
$$\begin{matrix}XN \leq B * \frac{{R}_{11 b}}{{d}_{1}^{2}} * 1 {0}^{5} \\ - where B = 8500 {mm}^{*} rev / min .\end{matrix}$$

18. The operating method according to claim 1, wherein the propulsion system is dimensioned such that the redline speed of the drive shaft further satisfies the following formula:
$$XN \geq \frac{1}{C} * \frac{{R}_{11 b}}{{d}_{1}^{2}} * 1 {0}^{8} * ( \frac{{R}_{m}}{{d}_{2}} * 1000 - {E}_{1} )$$
where: Rm is a mean radius of the drive turbine, in millimetres;
d₂ is a distance between the centers of gravity of the two rear bearings, in millimetres; and
C=170 (mm*rev/min)⁻¹ and E₁=378.

19. The operating method according to claim 1, wherein the propulsion system is dimensioned such that the redline speed of the drive shaft further satisfies the following formula:
$$XN \leq \frac{1}{C} * \frac{{R}_{11 b}}{{d}_{1}^{2}} * 1 {0}^{8} * ( \frac{{R}_{m}}{{d}_{2}} * 1000 + {E}_{2} )$$
where: Rm is a mean radius of the drive turbine, in millimetres;
d₂ is a distance between the centers of gravity of the two rear bearings, in millimetres; and
C=170 (mm*rev/min)⁻¹ and E₂=180.

20. A method for manufacturing an aeronautical propulsion system comprising:
dimensioning the aeronautical propulsion system in accordance with claim 1; and
manufacturing the aeronautical propulsion system.
